(19) United States
(12) Patent Application Publication
(10) Pub. No.: US 2006/0002677 A1
(43) Pub. Date: Jan. 5, 2006

(54) Light guide reading board

(76) Inventor: Yung-Fa Lin, Panchiao City (TW)

Correspondence Address: Yung-Fa Lin, P. O. Box No. 6-57, Junghe, Taipei, 235, TW

(21) Appl. No.: 10/879,107

(22) Filed: Jun. 30, 2004

(51) Int. Cl. G02B 6/10

(52) U.S. Cl. 385/146

(57) ABSTRACT

A light guide reading board composed by a light guide plate and a shell is used for occasions without enough light, or at night. The device features on that a slot is arranged on a side of the shell for being disposed with a moveable magnifying glass frame while a light emission circuitry, recording circuitry, radio circuitry and a timer are also disposed inside the shell so as to make the device with multifunction.

### BACKGROUND OF THE INVENTION

a) Field of the Invention

The present invention relates to a light guide reading board, especially to a reading board having a light guide plate and a shell. By a light source inside the shell providing light, the light guide plate shines and is used at night or occasions without enough light.

b) Description of the Prior Art

Refer to Fig. 1, a conventional light guide board includes a light source inside a shell. The light emitted from the light source is reflected inside the light guide plate successfully so that the whole light guide plate is bright. The brightness of the light is just enough for reading and won't disturb others.

However, such kind of light guide reading board has just one function without other usages. In order to enhance the functions of the light guide reading board, the present invention is provided with the functions of lightening, amplifying, recording, receiving radios, and timing.

### SUMMARY OF THE INVENTION

Therefore, it is a primary object of the present invention to provide a light guide reading plate with multiple functions for increasing the market competitiveness.

### BRIEF DESCRIPTION OF THE DRAWINGS

An embodiment of the invention will now be described by way of example only, with reference to the accompanying drawing, in which:

Fig. 1 is a perspective view of a prior art;

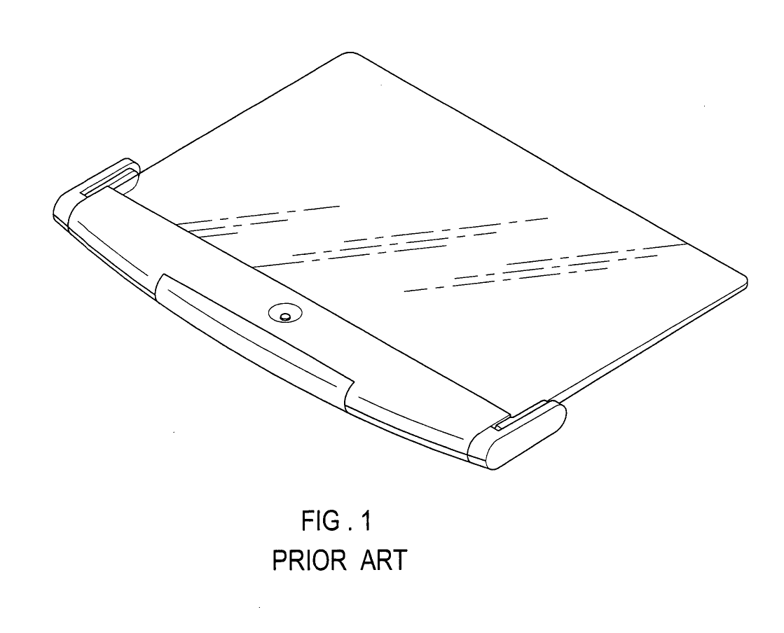

FIG. 2 is an explosive view of the present invention;

FIG. 3 is a perspective view of the present invention;

FIG. 4 is a schematic drawing of an embodiment of the present invention.

### DESCRIPTION OF THE PREFERRED EMBODIMENT

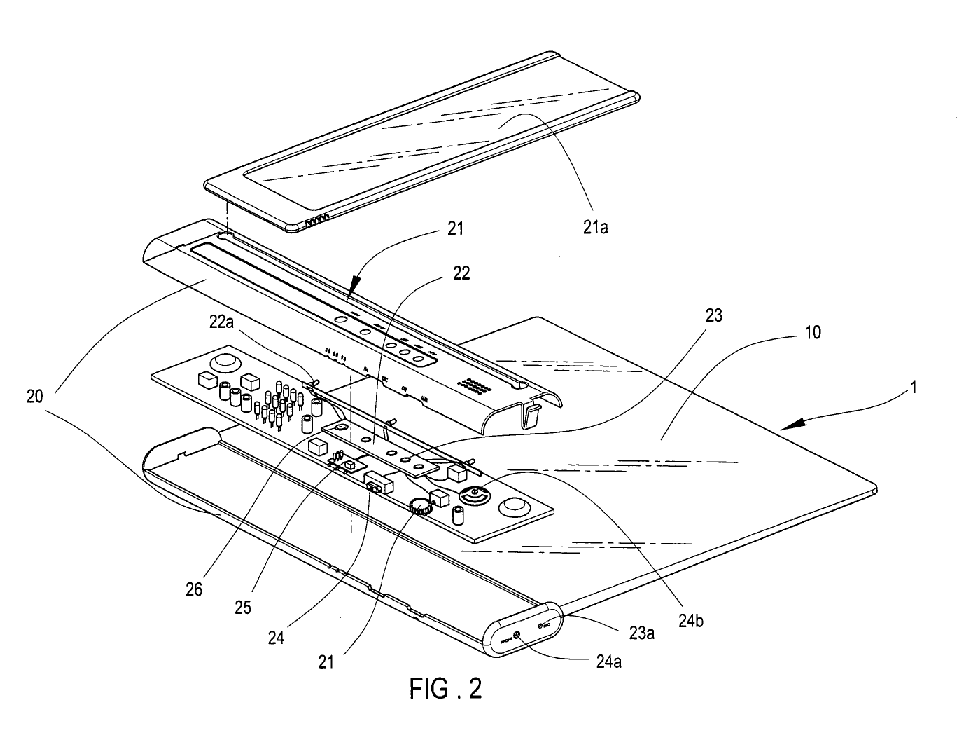

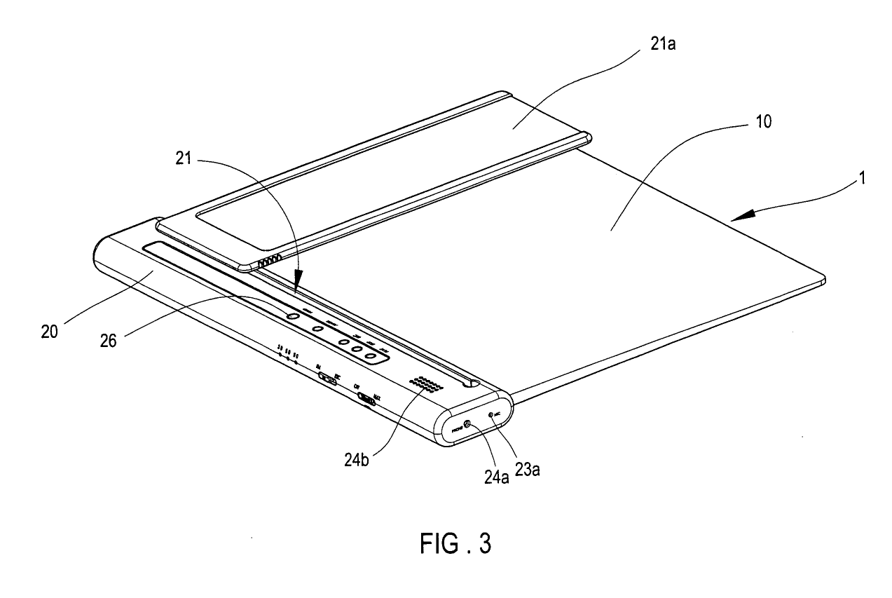

Refer to FIG. 2 & FIG. 3, a preferred embodiment of a light guide reading board 1 in accordance with the present invention is disclosed. The light guide reading board is composed of a light guide plate 10 and a shell 20. The light guide plate 10 is arranged on lateral side of the shell 20. A sliding slot 21 is disposed on top of the shell 20 while a magnifying glass frame 21a is extending outward from the sliding slot 21 and is moveable inside the sliding slot 21. A light emission circuitry 22, recording circuitry 23, radio circuitry 24 and a timer 25 are disposed inside the shell 20. A light source 22a of the light emission circuitry 22 is also installed inside the shell 20 and is controlled by an external switch. The light source 22a is a light bulb, light emitting diode (LED), or cold light. The recording circuitry 23 and the radio circuitry 24 are controlled and shifted by a switch 26. When the recording function is used, the recording circuitry 23 is connected to a microphone 23a that receives the voice signal and stored in side the memory of the recording circuitry 23. By an earphone jack 24a or a speaker 24b of the radio circuitry 24, users can listen the recorded signals. While receiving radios, users listen to the radio through the earphone jack 24a or the speaker 24b. The radio frequency and voice volume are regulated by a switch. The timer 25 is used to alarm users the preset time is up by voices or light.

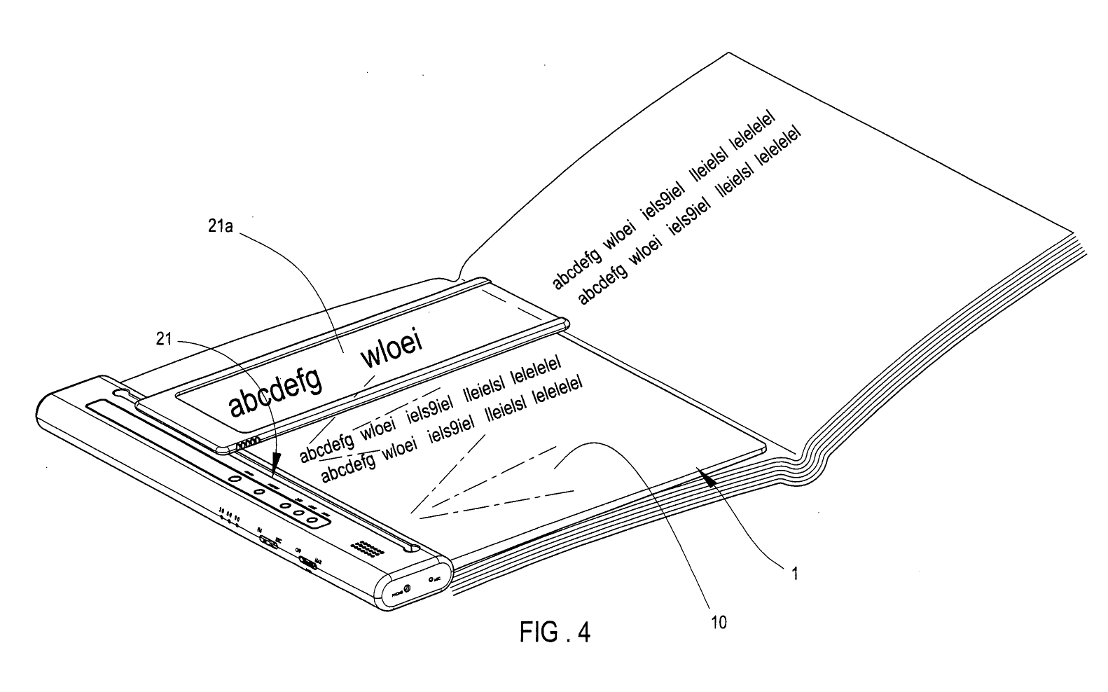

Refer to FIG. 4, it discloses an embodiment of the present invention. The light guide reading board 1 is set on top of the documents or material for reading. The light guide plate 10 is lighted by the light source 22a of the light emission circuitry 22. Through the magnifying glass frame 21a inside the sliding slot 21, the words on the documents or material for reading are magnifying and are more clear. Moreover, with the recoding function, the content of the speech is recorded without missing. The radio and timer also provide users some entertainment and time setting for some special events.

While a preferred embodiment of the invention has been shown and described in detail, it will be readily understood and appreciated that numerous omissions, changes and additions may be made without departing from the spirit and scope of the invention.

What is claimed is:

1. A light guide reading board comprising:
a light guide plate and a shell, wherein the present invention is characterized in that:
at least one light emission circuitry having a light source is arranged inside the shell for lighting the light guide plate extending from one side of the shell; a slot is arranged on top of the shell for being disposed with a moveable magnifying glass frame extending to the top of the light guide plate.

2. The light guide reading board as claimed in claim 1, wherein a recording circuitry, radio circuitry and a timer are arranged inside the shell.

3. The light guide reading board as claimed in claim 1, wherein the light source of the light emission circuitry is a light bulb.

4. The light guide reading board as claimed in claim 1, wherein the light source of the light emission circuitry is a light emitting diode (LED).

5. The light guide reading board as claimed in claim 1, wherein the light source of the light emission circuitry is a fluorescent lamp.
